(19) United States
(12) Patent Application Publication
(10) Pub. No.: US 2016/0194426 A1
(43) Pub. Date: Jul. 7, 2016

(54) RESIN

(71) Applicant: LG CHEM, LTD., Seoul (KR)

(72) Inventors: Houng Sik YOO, Daejeon (KR); Jin Young RYU, Daejeon (KR); Eun Joo CHOI, Daejeon (KR); Jong Won LEE, Daejeon (KR); Hyeon CHOI, Daejeon (KR)

(21) Appl. No.: 14/909,414

(22) PCT Filed: Aug. 1, 2014
(86) PCT No.: PCT/KR2014/007135

§ 371 Date: Feb. 1, 2016

(30) Foreign Application Priority Data
Aug. 2, 2013 (KR) 10-2013-0092133
Sep. 5, 2013 (KR) 10-2013-0106588
Aug. 1, 2014 (KR) 10-2014-0099023
Aug. 1, 2014 (KR) 10-2014-0099024

(51) Int. Cl. C08F 265/06; C08L 33/12

(52) U.S. Cl. CPC C08F 265/06; C08L 33/12

(57) ABSTRACT

Provided are a resin, a method of preparing the resin, a resin blend including the resin, a pellet, a method of preparing a resin article using the resin blend and the pellet, and the resin article. An exemplary resin in the present invention may provide a resin article of which a surface has improved mechanical characteristics and surface hardness. Further, the use of the resin enables the resin article to exhibit the above-described effects without an additional coating process for a surface of the resin article, thereby leading to a decrease in manufacturing time and cost and to an increase in productivity.

### TECHNICAL FIELD

The present invention relates to a resin, a method of preparing the resin, a resin blend including the resin, a pellet, a method of preparing a resin article using the resin blend and the pellet, and the resin article.

### BACKGROUND ART

Plastic resins have been used for various applications in automobile components, helmets, components of electric devices, components of textile spinning machines, toys, or pipes due to their easy processability and excellent properties such as tensile strength, modulus of elasticity, heat resistance, and the like.

Especially, resins used in home appliances, components of automobiles, toys and the like should have excellent surface hardness.

For example, to increase surface hardness of an extruded or injected resin article, a high-hardness coating process was additionally needed after an extrusion or injection process. Since such the coating process includes a spray process, toxic materials have been generated.

### DISCLOSURE

### Technical Problem

The present invention provides a resin, a method of preparing the resin, a resin blend including the resin, a pellet, a method of preparing a resin article using the resin blend and the pellet, and the resin article.

### Technical Solution

An embodiment of the present invention provides a resin which has a particle including a seed, a core, and a shell. For example, the resin includes a particle which has a seed containing a polymer derived from an alkyl (meth)acrylate monomer and a crosslinkable monomer; a core surrounding the seed and containing a polymer derived from an alkyl (meth)acrylate monomer, an aryl (meth)acrylate monomer, and a crosslinkable monomer; and a shell surrounding the core and containing a polymer derived from an alkyl (meth)acrylate monomer, an aryl (meth)acrylate monomer, and a compound of the following Formula 1.

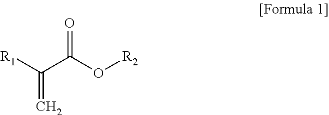

In Formula 1, R₁ represents hydrogen or an alkyl having 1 to 5 carbon atoms, and R₂ represents a compound of the following Formula 2.

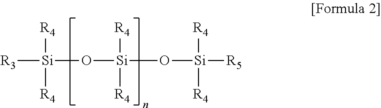

In Formula 2, R₃ represents an alkylene having 1 to 8 carbon atoms, R₄ and R₅ each independently represent hydrogen or an alkyl having 1 to 8 carbon atoms, and n represents an integer of 1 to 100.

Another embodiment of the present invention provides a method of preparing the resin. For example, the method of preparing the resin is performed in the presence of an anionic surfactant and a water-soluble polymerization initiator, and includes (A) preparing a seed by polymerizing an alkyl (meth)acrylate monomer and a crosslinkable monomer; (B) preparing a core which surrounds the seed, by additionally polymerizing an alkyl (meth)acrylate monomer, an aryl (meth)acrylate monomer, and a crosslinkable monomer, in the presence of the seed; and (C) preparing a shell which surrounds the core, in the presence of the core, by polymerizing an alkyl (meth)acrylate monomer, an aryl (meth)acrylate monomer, and a compound of Formula 1 using a water-soluble initiator.

Still another embodiment of the present invention provides a resin blend including a first resin; and a second resin which has a difference in surface energy or melt viscosity from the first resin. In the resin blend, the second resin includes a particle which has a seed containing a polymer derived from an alkyl (meth)acrylate monomer and a crosslinkable monomer; a core surrounding the seed and containing a polymer derived from an alkyl (meth)acrylate monomer, an aryl (meth)acrylate monomer, and a crosslinkable monomer; and a shell surrounding the core and containing a polymer derived from an alkyl (meth)acrylate monomer, an aryl (meth)acrylate monomer, and a compound of the following Formula 1.

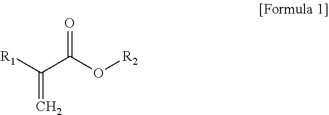

In Formula 1, R₁ represents hydrogen or an alkyl having 1 to 5 carbon atoms, and R₂ represents a compound of the following Formula 2.

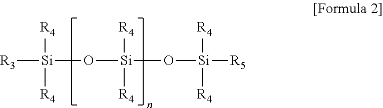

In Formula 2, R₃ represents an alkylene having 1 to 8 carbon atoms, R₄ and R₅ each independently represent hydrogen or an alkyl having 1 to 8 carbon atoms, and n represents an integer of 1 to 100.

Still another embodiment of the present invention provides a pellet including a core formed of a first resin; and a shell formed of a second resin which has a difference in surface energy or melt viscosity from the first resin.

Still another embodiment of the present invention provides a method of preparing a resin article, which includes forming a melt blend by melting the resin blend; and forming a layer-separated structure by processing the melt blend.

Still another embodiment of the present invention provides a method of preparing a resin article, which includes forming a melt blend by melting the pellet; and forming a layer-separated structure by processing the melt blend.

Still another embodiment of the present invention provides a resin article including a first resin layer; a second resin layer formed on the first resin layer; and an interface layer including a first and a second resins and interposed between the first resin layer and the second resin layer. In the resin article, the second resin includes a particle having a seed containing a polymer derived from an alkyl (meth)acrylate monomer and a crosslinkable monomer; a core surrounding the seed and containing a polymer derived from an alkyl (meth)acrylate monomer, an aryl (meth)acrylate monomer, and a crosslinkable monomer; and a shell surrounding the core and containing a polymer derived from an alkyl (meth)acrylate monomer, an aryl (meth)acrylate monomer, and a compound of the following Formula 1.

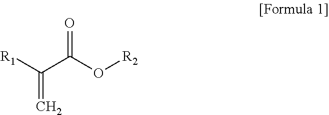

In Formula 1, R₁ represents hydrogen or an alkyl having 1 to 5 carbon atoms, and R₂ represents a compound of the following Formula 2.

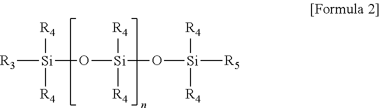

In Formula 2, R₃ represents an alkylene having 1 to 8 carbon atoms, R₄ and R₅ each independently represent hydrogen or an alkyl having 1 to 8 carbon atoms, and n represents an integer of 1 to 100.

Hereinafter, a resin, the method of preparing the resin, a resin blend, a pellet, a method of preparing a resin article using the resin blend and the pellet, and a resin article will be described in detail in accordance with embodiments of the present invention.

In the embodiment, the resin may be a resin including a particle that has a triple structure of seed-core-shell. For example, the resin may be prepared by polymerizing a seed from an alkyl (meth)acrylate monomer and a crosslinkable monomer, polymerizing a core which surrounds the seed from an alkyl (meth)acrylate monomer, an aryl (meth)acrylate monomer, and a crosslinkable monomer, and graft polymerizing a shell which surrounds the core from an alkyl (meth)acrylate monomer, an aryl (meth)acrylate monomer, and a compound of the following Formula 1.

In the above, the term “seed” refers to a part located at the innermost side of the triple structure, the term “core” refers to a part which surrounds the seed and is disposed between the seed and the shell in the triple structure, and the “shell” refers to the outermost side of the triple structure surrounding the core.

Further, in the above, the term “surround” denotes that a peripheral surface of a particle is formed to be substantially covered, and in the above, that the term “a peripheral surface of a particle is formed to be substantially covered” denotes that, for example, 50% or more, 60% or more, 70% or more, 80% or more, 90% or more, 95% or more, or 99% or more of a peripheral surface is formed to be covered.

In the embodiment, an alkyl (meth)acrylate monomer is used as a main monomer to polymerize a polymer included in the seed, core, and shell. As the alkyl (meth)acrylate, for example, an alkyl (meth)acrylate having 1 to 40 carbon atoms, an alkyl (meth)acrylate having 1 to 30 carbon atoms, an alkyl (meth)acrylate having 1 to 20 carbon atoms, an alkyl (meth)acrylate having 1 to 10 carbon atoms, an alkyl (meth)acrylate having 1 to 5 carbon atoms, an alkyl (meth)acrylate having 1 to 3 carbon atoms, and an alkyl (meth)acrylate having 1 to 2 carbon atoms may be used. The alkyl (meth)acrylate monomer may be one or more type(s) selected from a group consisting of methyl methacrylate, ethyl methacrylate, methyl acrylate, ethyl acrylate, n-propyl acrylate, isopropyl acrylate, n-butyl acrylate, isobutyl acrylate, hexyl acrylate, octyl acrylate, and 2-ethylhexyl acrylate, but it is not limited thereto.

A content of an alkyl (meth)acrylate forming a main polymerization unit may be properly controlled depending on a use of the resin and physical properties required by the seed, core and shell. For example, the content of the alkyl (meth)acrylate may be in a range of 50 to 97 parts by weight, a range of 60 to 95 parts by weight, a range of 65 to 90 parts by weight, a range of 50 to 80 parts by weight, a range of 50 to 75 parts by weight, a range of 50 to 70 parts by weight, a range of 55 to 80 parts by weight, a range of 60 to 80 parts by weight, a range of 55 to 75 parts by weight, or a range of 60 to 70 parts by weight based on 100 parts by weight of total monomers included in a monomer blend to prepare a polymer contained in the resin.

In the embodiment, a polymerization unit of a polymer contained in the seed, core, and shell may include a monomer having a bulky functional group besides the above-described alkyl (meth)acrylate monomer. The polymer formed from a monomer blend including a monomer having a bulky functional group may increase hydrodynamic volume and then provide a resin with low melt viscosity, and increase a glass transition temperature and then provide a resin with high hardness.

In the embodiment, a monomer having a bulky functional group included in a polymerization unit of a polymer in the seed may be an alkyl (meth)acrylate. Accordingly, a monomer blend to form a polymer included in the seed may contain, for example, an alkyl (meth)acrylate which forms a main polymerization unit in the above-described polymer; and two or more types of alkyl (meth)acrylates including an alkyl (meth)acrylate having a bulky alkyl group. As the alkyl (meth)acrylate having a bulky alkyl group, for example, an alkyl (meth)acrylate having 3 to 20 carbon atoms, 3 to 12 carbon atoms, 3 to 6 carbon atoms, 5 to 20 carbon atoms, 7 to 20 carbon atoms, 10 to 20 carbon atoms, or 12 to 20 carbon atoms may be used; an alicyclic (meth)acrylate having 5 to 40 carbon atoms, 5 to 25 carbon atoms, 5 to 16 carbon atoms, 6 to 40 carbon atoms, 10 to 40 carbon atoms, 12 to 40 carbon atoms, or 16 to 40 carbon atoms, or the like may be used. Particularly, as the alkyl (meth)acrylate having 3 to 20 carbon atoms, for example, isopropyl (meth)acrylate, isobutyl (meth)acrylate, tertiarybutyl (meth)acrylate, 2-ethylhexyl (meth)acrylate, or the like may be used, and as the alicyclic (meth)acrylate having 5 to 40 carbon atoms, for example, cyclohexyl (meth)acrylate or isobornyl (meth)acrylate may be used.

A content of the alkyl (meth)acrylate having a bulky alkyl group may be properly controlled according to melt viscosity of the resin and physical properties required by the seed. For example, the content of the alkyl (meth)acrylate having the bulky alkyl group, may be adjusted to be in a range of 10 to 40 parts by weight, a range of 15 to 40 parts by weight, a range of 20 to 40 parts by weight, a range of 10 to 35 parts by weight, a range of 10 to 30 parts by weight, a range of 15 to 35 parts by weight, or a range of 20 to 30 parts by weight based on 100 parts by weight of total monomers included in a monomer blend to prepare a polymer contained in the seed.

In another example, as a monomer having a bulky functional group, an aryl (meth)acrylate (aromatic (meth)acrylate) may be used. In the embodiment, a monomer having a bulky functional group included in a polymerization unit of a polymer contained in the core and shell may be an aryl (meth)acrylate. The aryl (meth)acrylate may be, for example, an aryl (meth)acrylate having 6 to 40 carbon atoms, 6 to 25 carbon atoms, 6 to 16 carbon atoms, or the like. Particularly, as the aryl (meth)acrylate having 6 to 40 carbon atoms, for example, naphthyl (meth)acrylate, phenyl (meth)acrylate, anthracenyl (meth)acrylate, benzyl (meth)acrylate, or the like may be used.

A content of the aryl (meth)acrylate may also be properly controlled according to the purpose of use of the resin and physical properties required by the core and shell as the above-described (meth)acrylate having a bulky alkyl group. For example, content of an aromatic (meth)acrylate, may be adjusted to be in a range of 10 to 40 parts by weight, a range of 15 to 40 parts by weight, a range of 20 to 40 parts by weight, a range of 10 to 35 parts by weight, a range of 10 to 30 parts by weight, a range of 15 to 35 parts by weight, or a range of 20 to 30 parts by weight based on 100 parts by weight of total monomers included in a monomer blend to prepare a polymer contained in the core or shell.

Hereinafter, each part of the seed, the core, and the shell of a particle having the triple structure will be described.

As the seed is a part located at the innermost side of the particle having the triple structure, the seed may contain a polymer derived from an alkyl (meth)acrylate monomer and a crosslinkable monomer.

The alkyl (meth)acrylate monomer is used as a main monomer to prepare the above-described polymer, and detailed descriptions thereof are the same as described above.

Moreover, a polymer included in the seed may be polymerized additionally including a crosslinkable monomer to further improve impact resistance and processability besides the alkyl (meth)acrylate monomer. In the embodiment, the crosslinkable monomer may use one or more selected from a group consisting of 3-butanediol diacrylate, 1,3-butanediol dimethacrylate, 1,4-butanediol diacrylate, 1,4-butanediol dimethacrylate, allyl acrylate, allyl methacrylate, trimethylolpropane triacrylate, tetraethyleneglycol diacrylate, tetraethyleneglycol dimethacrylate, and divinylbenzene, but is not limited thereto.

In the embodiment, a polymer included in the seed may contain a polymerization unit which is polymerized at contents of 5 to 99.5 parts by weight of the alkyl (meth)acrylate monomer and 0.5 to 5 parts by weight of the crosslinkable monomer.

A diameter of a particle including the seed may be controlled to be in a wide range according to an entire diameter of the particles having the triple structure, but is not limited thereto, for example, an average diameter of particles including the seed may be in a range of 10 to 1,000 nm, e.g., a range of 50 to 900 nm or a range of 100 to 500 nm.

In the embodiment, the seed may be in a glass phase at a room temperature.

The core, as a part to enhance hardness of the resin, surrounds the seed and contains the above-described polymer derived from an alkyl (meth)acrylate monomer, an aryl (meth)acrylate monomer, and a crosslinkable monomer.

Since an alkyl (meth)acrylate monomer is the main monomer included in a polymerization unit of a polymer contained in the core, the aryl (meth)acrylate monomer is the above-described monomer having bulky functional group and the crosslinkable monomer is the same monomer as a crosslinkable monomer applied to the seed, detailed descriptions thereof are the same as described above.

In the embodiment, a polymer included in the core, may include a polymerization unit polymerized at contents of 10 to 80 parts by weight of the alkyl (meth)acrylate monomer, 20 to 40 parts by weight of the aryl (meth)acrylate monomer, and 0.01 to 5 parts by weight of the crosslinkable monomer. Further, the crosslinkable monomer in the polymerization unit of a polymer included in the core may be contained at contents of 0.01 to 5 parts by weight, or 0.05 to 3 parts by weight with respect to 100 parts by weight of any remaining monomer except the crosslinkable monomer, and when the content of the crosslinkable monomer is less than 0.01 parts by weight, the improvement in surface hardness of the resin may be insignificant, and when the content is more than 5 parts by weight, impact resistance of the resin may be decreased.

A diameter of the core may be adjusted in a wide range according to the entire diameter of the particles having the triple structure, but is not particularly limited thereto. For example, an average diameter of the cores may be in a range of 10 to 5,000 nm, e.g., a range of 50 to 4,000 nm or a range of 100 to 2,000 nm.

In the embodiment, the core may be in a rubber phase at a room temperature.

The shell is located at the outermost side of the particle having the triple structure, as a part to increase an efficiency of a layer-separation in a resin blend as described below, surrounds the core and includes a particle having a shell which contains a polymer derived from an alkyl (meth)acrylate monomer, an aryl (meth)acrylate monomer, and a compound of the following Formula 1.

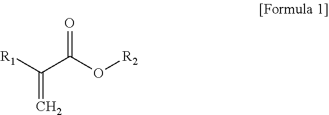

In Formula 1, R₁ represents hydrogen or an alkyl having 1 to 5 carbon atoms, and R₂ represents a compound of the following Formula 2.

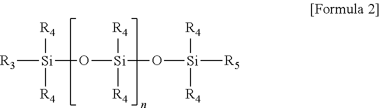

In Formula 2, R₃ represents an alkylene having 1 to 8 carbon atoms, R₄ and R₅ each independently represent hydrogen or an alkyl having 1 to 8 carbon atoms, and n represents an integer of 1 to 100.

An alkyl (meth)acrylate monomer included in a polymerization unit of a polymer contained in the shell is the main monomer of a polymer, the aryl (meth)acrylate monomer is the above-described monomer having bulky functional group, and detailed descriptions thereof are the same as described above.

In the embodiment, a compound of Formula 1 may be a compound in which a hydrophobic functional group, for example, a polydimethyl siloxane functional group is introduced to a position of R₂ of a (meth)acrylate monomer, also as an example, a compound of Formula 2 which is a compound of the position R₂ may be a methacrylate including a polydimethyl siloxane unit, and an efficiency of a layer-separation from a first resin may be increased in a resin blend as described below due to the hydrophobic functional group.

In the embodiment, a polymer included in the shell may contain a polymerization unit polymerized at contents of 10 to 90 parts by weight of the alkyl (meth)acrylate monomer, 20 to 30 parts by weight of the aryl (meth)acrylate monomer, and 1 to 50 parts by weight of the compound of Formula 1.

A diameter of a particle including the shell may be, for example, the entire diameter of the particles having the triple structure, but is not particularly limited. For example, an average diameter of particles including the shell may be in a range of 10 to 10,000 nm, e.g., a range of 100 to 7,000 nm or a range of 50 to 5,000 nm. When the diameter is less than 10 nm, surface hardness of a prepared resin may be decreased, and when the diameter is greater than 10,000 nm, impact resistance of the resin may be decreased.

In the embodiment, the shell may be in a glass phase at a room temperature.

A content of a core in the particle which has the triple structure of seed-core-shell included in an exemplary resin of the present invention may be in a range of 1 to 150 parts by weight, e.g., a range of 1 to 120 parts by weight, a range of 3 to 130 parts by weight, or a range of 5 to 110 parts by weight with respect to 10 parts by weight of the seed.

Further, a content of a shell of the particle may be in a range of 5 to 100 parts by weight, e.g., a range of 5 to 80 parts by weight, a range of 7 to 70 parts by weight, or a range of 10 to 80 parts by weight with respect to 10 parts by weight of the seed.

The present invention also relates to a method of preparing the resin.

In the embodiment, the preparation method may be a method of preparing a particle having the above-described triple structure of seed-core-shell, and includes preparing a seed; preparing a core surrounding the seed; and preparing a shell surrounding the core.

For example, the preparation method includes (A) preparing a seed by polymerizing an alkyl (meth)acrylate monomer and a crosslinkable monomer; (B) preparing a core surrounding the seed by additionally polymerizing an alkyl (meth)acrylate monomer, an aryl (meth)acrylate monomer, and a crosslinkable monomer in the presence of the seed; (C) preparing a shell surrounding the core, by polymerizing an alkyl (meth)acrylate monomer, an aryl (meth)acrylate monomer, and a compound of the following Formula 1 using a water-soluble initiator in the presence of the core, and an effect thereof is omitted because it is the same as described above.

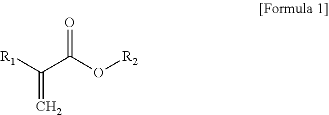

In Formula 1, R₁ represents hydrogen or an alkyl having 1 to 5 carbon atoms, and R₂ represents a compound of the following Formula 2.

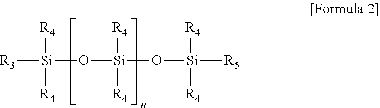

In Formula 2, R₃ represents an alkylene having 1 to 8 carbon atoms, R₄ and R₅ each independently represent hydrogen or an alkyl having 1 to 8 carbon atoms, and n represents an integer of 1 to 100.

In the embodiment, the preparation method is performed in the presence of an anionic surfactant and a water-soluble polymerization initiator.

In the embodiment, the anionic surfactant may use a variety of anionic surfactants well-known in the technical field, for example, one or more selected from a group consisting of an alkyl aryl ether sulfate having 6 to 16 carbon atoms of an alkyl, an alkyl ether sulfate having 6 to 16 carbon atoms of an alkyl, sodium dodecyl sulphate (SLS), sodium dodecylbenzensulfonate, an alkyl disulphonated diphenyl oxide, sodium lauryl sulfate, and sodium dihexyl sulfosuccinate, but is not particularly limited thereto.

The water-soluble polymerization initiator may also be used without limitation as long as it is one of a variety of water-soluble polymerization initiators well-known in the technical field. For example, it may be one or more selected from a group consisting of sodium persulfate, potassium persulfate, ammonium persulfate, t-butyl hydroperoxide (tBHP), 4.4′-azobis(4-cyanovaleric acid), and 2,2′-azobis(2-amidinopropane)dihydrochloride.

In the above preparation method, a monomer blend including the above-described monomer may generally provide a polymer using a method of preparing a resin through polymerization of a monomer. For example, through polymerization of a monomer blend using a method such as bulk polymerization, solution polymerization, suspension polymerization, emulsion polymerization, or the like, a polymer having the triple structure of seed-core-shell may be provided.

In the embodiment, a step of preparing the seed may additionally include a step of dispersing a dispersant in a solvent; a step of dispersing the above-mentioned alkyl (meth)acrylate monomer and crosslinkable monomer in the solvent; a step of adding an additive such as the above-described anionic surfactant, water-soluble polymerization initiator, or the like to the solvent and mixing the solvent and the additive; and a step of a polymerizing the mixture in which a reaction temperature is 40° C. or more. Here, an order of each step may be modified arbitrarily, and two or more steps may proceed as one step.

The solvent may use any medium, known to be used to generally prepare the seed, without limitation. As the solvent, for example, methyl ethyl ketone, ethanol, methyl isobutyl ketone, distilled water, or the like may be used, or a combination of two or more thereof may be used.

As a dispersant which may be added to the solvent, for example, an organic dispersant such as polyvinyl alcohol, polyolefin-maleic acid, cellulose, or the like; or an inorganic dispersant such as tricalcium phosphate may be utilized.

In addition, in preparing an acrylic polymer, an additive which is typically used in the polymer industry may be utilized and a process which is typically performed may be performed additionally.

Further, in the embodiment, a step of preparing the core may additionally include a step of dispersing the above-described alkyl (meth)acrylate monomer, aryl (meth)acrylate monomer, and crosslinkable monomer in a solution including the seed; a step of adding an additive such as the above-described anionic surfactant, water-soluble polymerization initiator, or the like to the solvent and mixing the solvent and the additive; and a step of polymerizing the mixture in which a reaction temperature is 40° C. or more. Here, an order of each step may be modified arbitrarily, and two or more steps may proceed as one step.

Moreover, a step of preparing the shell may additionally include a step of dispersing the above-described alkyl (meth)acrylate monomer and compound of Formula 1 to a solution including the seed-core polymer; a step of adding an additive such as a chain transfer agent, an anionic surfactant, a water-soluble polymerization initiator and the like to the solvent and mixing the solvent and the additive; and a step of a polymerizing the mixture in which a reaction temperature is 40° C. or more. Here, an order of each step may be modified arbitrarily, and two or more steps may proceed as one step.

As the chain transfer agent, for example, an alkyl mercaptan such as n-butyl mercaptan, n-dodecyl mercaptan, tertiary dodecyl mercaptan, isopropyl mercaptan, or the like; an aryl mercaptan such as phenyl mercaptan, naphthyl mercaptan, benzyl mercaptan, or the like; a halogen compound such as carbon tetra chloride or the like; an aromatic compound such as alpha-methylstyrene dimer, alpha-ethylstyrene dimer, or the like, may be used.

The present invention also relates to a resin blend including the resin, a pellet, a resin article using the resin and the pellet, and a method of preparing the resin article. The resin may be utilized in a variety of applications in the form of a mixture and with a different type of resin having different physical properties. Hereinafter, the resin blend including the resin, the pellet, the method of preparing a resin article using the resin and the pellet, and the resin article will be described in detail. The resin of the present invention is defined as the term “a second resin” in the following resin blend, and the different type of resin which is different in physical properties from the resin of the present invention is defined as the term “a first resin” in the following resin blend.

As described above, the term “blend” may be a mixture of two or more different types of resins. A type of blend may include a mixture of two or more types of resins in one matrix, or a mixture of two or more types of pellets, but is not specifically limited thereto. Each of the resins may have different physical properties, for example, the physical properties may be surface energy, melt viscosity, or a solubility parameter.

The term “melt-processing” denotes a process to melt a resin blend at more than a melting temperature (Tm) in order to form a melt blend and to prepare a desired resin article using the melt blend. For example, injection molding, extrusion, blow molding, transfer molding, film blowing, fiber spinning, calendaring thermoforming, foam molding, or the like may be utilized.

The term “resin article” denotes a pellet or a product formed from a resin blend, the resin articles may be, for example, automobile parts, parts of electric devices, parts of machines, functional films, toy, or pipes, but are not specifically limited thereto.

The term “layer separation” may denote that a layer formed of a resin is positioned or arranged on a layer formed of a substantially different resin. A layer substantially formed of a resin may denote that one type of resin does not form a sea-island structure and exists continually in an entire layer. A sea-island structure indicates that a phase-separated resin is partially distributed in an entire resin blend. Further, the term “substantially formed” may denote that one resin is present or rich in one layer.

In the embodiment, a resin blend may be layer-separated by melt-processing. Thus, a resin article of which a surface has a specific function, e.g., high hardness, may be prepared without an additional processing such as coating or plating. Accordingly, a resin article may have enhanced mechanical properties and surface characteristics, and with the use of the resin blend, a manufacturing cost and a time of the resin article may be decreased.

A layer-separation of the resin blend may occur due to a difference in physical properties between a first resin and a second resin and/or a molecular weight distribution of a second resin, etc. Here, the physical properties may be, for example, surface energy, melt viscosity or a solubility parameter. While a resin blend including two types of resins is described in the present specification, it will be apparent to those skilled in the art that three or more types of resins which have different physical properties may be mixed and layer-separated by melt-processing.

According to an embodiment, a resin blend may include a first resin and a second resin having a difference of 0.1 to 35 mN/m in surface energy from the first resin at 25° C.

The difference in surface energy between the first resin and the second resin at 25° C. may be in a range of 0.1 to 35 mN/m, a range of 0.1 to 30 mN/m, a range of 0.1 to 20 mN/m, a range of 0.1 to 15 mN/m, a range of 0.1 to 7 mN/m, a range of 1 to 35 mN/m, a range of 1 to 30 mN/m, a range of 2 to 20 mN/m, or a range of 3 to 15 mN/m. When using the first and the second resins having a difference within the above range in surface energy, the first and second resins may not be delaminated and the second resin may easily move to a surface, thereby facilitating generation of a layer-separation.

A resin blend of a first resin and second resin having a difference of 0.1 to 35 mN/m in surface energy at 25° C. may be layer-separated by melt-processing. As an example, when a resin blend of a first resin and a second resin is melt-processed and the melt-processed resin blend is exposed to ambient air, the first resin and the second resin may be separated due to a difference in a hydrophobic property. In particular, as the second resin with lower surface energy than the first resin has a high hydrophobic property, it may move to contact ambient air and form the second resin layer at near the ambient air. Further, the first resin may contact the second layer and be opposite the ambient air. Thus, a layer separation may occur between the first resin and the second resin in the resin blend.

The resin blend may be separated into two or more layers. In the embodiment, the resin blend including the first resin and the second resin may be separated into three layers, e.g., the second resin layer/the first resin layer/the second resin layer, when two surfaces, which are opposite, of the melt-processed resin blend are exposed to ambient air. Meanwhile, the resin blend may be layer-separated into two layers, e.g., the second resin layer/the first resin layer, when only one surface of the melt-processed resin blend is exposed to ambient air. Further, when a resin blend including a first resin, a second resin, and a third resin which have differences in surface energy is melt-processed, the melt-processed resin blend may be layer-separated into five layers, e.g., the third resin layer/the second resin layer/the first resin layer/the second resin layer/the third resin layer. Moreover, when all surfaces of the melt-processed resin blend are exposed to ambient air, the resin blend may be layer-separated into all directions and form a core-shell structure.

In accordance with another embodiment, a resin blend may include a first resin; and a second resin having a difference of 0.1 to 3000 pa*s in melt viscosity from the first resin at a shear rate of 100 to 1000 s⁻¹ and a processing temperature of the resin blend.

A difference in melt viscosity between the first resin and second resin at a shear rate of 100 to 1000 s⁻¹ and at a processing temperature of the resin blend may be in a range of 0.1 to 3000 pa*s, a range of 1 to 2000 pa*s, a range of 1 to 1000 pa*s, a range of 1 to 500 pa*s, a range of 50 to 500 pa*s, a range of 100 to 500 pa*s, a range of 200 to 500 pa*s, or a range of 250 to 500 pa*s. When using the first and a second resins having a difference within the above range in melt viscosity, the first and second resins may not be delaminated and a layer-separation may easily occur as the second resin easily moves to a surface.

A resin blend, in which the difference in melt viscosity between a first resin and a second resin at a shear rate of 100 to 1000 s⁻¹ and a processing temperature of the resin blend is in a range of 0.1 to 3000 pa*s, may be layer-separated after melt-processing due to the difference in melt viscosity. As an example, when a resin blend of a first resin and a second resin is melt-processed and the melt-processed resin blend is exposed to ambient air, the first resin and the second resin may be separated due to a difference in fluidity between the first resin and second resin. In particular, since the second resin having a lower melt viscosity compared to the first resin has a higher fluidity than the first resin, the second resin may move to contact ambient air and form the second resin layer at near the ambient air. Further, the first resin may contact the second layer and be opposite the ambient air. Thus, a layer separation may occur between the first resin and the second resin in the resin blend.

The melt viscosity may be measured by capillary flow, which denotes a shear viscosity (pa*s) according to a specific processing temperature and a shear rate (s⁻¹).

The term “shear rate” denotes a shear rate to be applied when the resin blend is processed, a shear rate may be controlled in a range of 100 to 1000 s⁻¹ according to a processing method. A control of the shear rate according to a processing method will be apparent to those skilled in the art.

The term “processing temperature” indicates a temperature of processing the resin blend. For example, when the resin blend is used in melt-processing such as extrusion, injection or the like, the processing temperature indicates a temperature to be applied in the melt-processing. The processing temperature may be controlled depending on a resin subjected to melt-processing such as extrusion, injection, or the like. For example, a resin blend including a first resin of ABS resin and a second resin obtained from an acrylic monomer may have a processing temperature of 210 to 270° C.

According to another embodiment of the present invention, a resin blend of forming a layer-separated structure, which includes a first resin and a second resin having a difference of 0.001 to 10.0 (J/cm³)^{1/2} in a solubility parameter from the first resin at 25° C., may be provided.

A difference in the solubility parameter between the first resin and the second resin at 25° C. may be in a range of 0.001 to 10.0 (J/cm³)^{1/2}, a range of 0.01 to 5.0 (J/cm³)^{1/2}, a range of 0.01 to 3.0 (J/cm³)^{1/2}, a range of 0.01 to 2.0 (J/cm³)^{1/2}, a range of 0.1 to 1.0 (J/cm³)^{1/2}, a range of 0.1 to 10.0 (J/cm³)^{1/2}, a range of 3.0 to 10.0 (J/cm³)^{1/2}, a range of 5.0 to 10.0 (J/cm³)^{1/2} or a range of 3.0 to 8.0 (J/cm³)^{1/2}. The solubility parameter is a unique feature that reflects solubility depending on polarity of the molecules of each resin, and the solubility parameter of each resin is generally known. When the difference in the solubility parameter is less than 0.001 (J/cm³)^{1/2}, a layer separation does not easily occur because the first resin and the second resin are easily mixed. When the difference in the solubility parameter is greater than 10.0 (J/cm³)^{1/2}, the first resin and the second resin may not be combined and may be delaminated.

The upper and/or lower limits of the difference in the solubility parameter may be any arbitrary value in a range of 0.001 to 10.0 (J/cm³)^{1/2}, and be dependent on the physical properties of a first resin. Especially, when the first resin is used as a base resin and a second resin is used as a functional resin to improve surface properties of the first resin, the second resin may be selected so that a difference in the solubility parameter between the first resin and the second resin at 25° C. is in a range of 0.001 to 10.0 (J/cm³)^{1/2}. In the embodiment, the difference in the solubility parameter may be selected in consideration with miscibility of the second resin in a melt blend of the first resin and the second resin.

A resin blend of a first resin and second resin having a difference of 0.001 to 10.0 (J/cm³)^{1/2} in the solubility parameter at 25° C. may be layer-separated after melt-processing, due to the difference in the solubility parameter. In the embodiment, when a resin blend of the first resin and the second resin is melt-processed and the melt-processed resin blend is exposed to ambient air, the first resin and the second resin may be separated due to the degree of miscibility. Particularly, the second resin having a difference of 0.001 to 10 (J/cm³)^{1/2} in the solubility parameter from a first resin at 25° C. may be immiscible with the first resin. Therefore, when the second resin additionally has lower surface tension or lower melt viscosity than that of the first resin, the second resin may move to contact ambient air and form the second resin layer at near the ambient air. Further, the first resin may contact the second layer and be opposite the ambient air. Thus, a layer separation may occur between the first resin and the second resin of the resin blend.

In the above resin blend, a first resin, as a resin which determines physical properties of a desired resin article, may be selected according to types of the desired resin article and processing conditions. As the first resin, a synthetic resin may be used without limitation.

As a first resin, for example, a styrene-based resin such as an acrylonitrile butadiene styrene (ABS)-based resin, a polystyrene-based resin, an acrylonitrile styrene acrylate (ASA)-based resin, or a styrene-butadiene-styrene block copolymer-based resin; a polyolefin-based resin such as a high density polyethylene-based resin, a low density polyethylene-based resin, or a polypropylene-based resin; a thermoplastic elastomer such as an ester-based thermoplastic elastomer or olefin-based thermoplastic elastomer; a polyoxyalkylene-based resin such as a polyoxymethylene-based resin or a polyoxyethylene-based resin; a polyester-based resin such as a polyethylene terephthalate-based resin or a polybutylene terephthalate-based resin; a polyvinylchloride-based resin; a polycarbonate-based resin; a polyphenylenesulfide-based resin; a vinyl alcohol-based resin; a polyamide-based resin; an acrylate-based resin; engineering plastics; or a copolymer or combination thereof, may be utilized. As engineering plastics, plastics exhibiting excellent mechanical and thermal properties may be used. For example, polyetherketone, polysulfone, polyimide, and so forth may be used as engineering plastics. In the embodiment, as a first resin, a copolymer obtained by polymerizing acrylonitrile, butadiene, styrene, and an acrylic monomer may be used.

In the resin blend, a second resin may include an exemplary resin having a particle with a triple structure of seed-core-shell in the present invention, and descriptions thereof are the same as described above.

In the embodiment, a weight-average molecular weight (Mw) of a second resin may be in a range of 5,000 to 200,000. Further, in another example, a weight-average molecular weight of the second resin may be controlled in a range of 10,000 to 200,000, 15,000 to 200,000, 20,000 to 200,000, 5,000 to 180,000, 5,000 to 150,000, 5,000 to 120,000, 10,000 to 180,000, 15,000 to 150,000, or 20,000 to 120,000. For example, when a second resin having a weight-average molecular weight in the above range is applied to a resin blend for melt-processing, since the second resin has a proper fluidity, a layer-separation may easily occur.

Further, in the embodiment, a polydispersity index (PDI) of the second resin may be controlled in a range of 1 to 2.5, 1 to 2.2, 1.5 to 2.5, or 1.5 to 2.2. For example, when a second resin having a polydispersity index in the above range is applied to a resin blend for melt-processing, since the low molecular weight portion and/or high molecular weight portion of the second resin which interferes with a generation of layer-separation is decreased, a layer-separation may easily occur.

In the embodiment, a resin blend may include a second resin of 0.1 to 50 parts by weight based on 100 parts by weight of a first resin. Further, in another example, a resin blend may include a second resin of 1 to 30 parts by weight, 1 to 20 parts by weight, or 1 to 15 parts by weight based on 100 parts by weight of a first resin. When a resin blend includes a first resin and a second resin at the above amount, a layer-separation may be induced and an amount of the second resin which is relatively expensive compared to the first resin is appropriately controlled such that an economical resin blend may be provided.

The resin blend described above may prepare as a pellet by extrusion. In the pellet produced using the resin blend, a first resin may form a core and a second resin may be layer-separated from the first resin to form a shell.

According to an embodiment, a pellet including a core formed of a first resin and a shell formed of a second resin which has a particle with a triple structure of seed-core-shell and has a difference in surface energy, melt viscosity, or the solubility parameter from the first resin is provided.

Further, the first resin and the second resin may have differences in surface energy, melt viscosity, or the solubility parameter as described above. For example, the first resin and the second resin may have a difference of 0.1 to 35 mN/m in surface energy at 25° C.; and a difference of the pellet of 0.1 to 3000 pa*s in melt viscosity at a shear rate of 100 to 1000 s⁻¹ and at a processing temperature.

Since types and physical properties of the first resin and the second resin have already been described above in detail, further descriptions thereof will be omitted.

Meanwhile, the above-described resin blend or pellet may provide a resin article having a layer-separated structure by melt-processing.

According to an embodiment, a method of preparing a resin article which includes forming a melt blend by melting a resin blend and forming a layer-separated structure by processing the melt blend may be provided.

As described above, a layer separation may occur during the melt-processing of the resin blend due to a difference in physical properties between the first resin and the second resin, and the layer separation may provide for the effect of selectively coating a surface of the pellet or the resin article without an additional process.

Particularly, when a resin having a triple structure of seed-core-shell is used as the second resin, a portion of the shell having relatively lower surface energy or melt viscosity is located at the surface of the resin article during melt-processing, and thus, the resin article with enhanced mechanical properties and surface characteristics may be provided.

A step of melt-processing a resin blend may be performed under shear stress. For example, a step of melt-processing may be performed by a method of extrusion and/or injection process(es).

Further, in a step of melt-processing a resin blend, a temperature to be applied may vary depending on the types of a first resin and a second resin used. For example, when a styrene-based resin is used as the first resin and an acryl-based resin is used as the second resin, a melt-processing temperature may be controlled in a range of about 210 to 270° C.

A method of preparing a resin article may further include curing a resulting product obtained by melt-processing the resin blend, i.e., a melt-processed product of the resin blend. The curing may be, for example, a thermal curing and/or UV curing. Further, chemical or physical treatment may be additionally performed on the resin article.

In the embodiment, a method of preparing a resin article may further include preparing a second resin before forming a melt blend by melting the resin blend. A second resin may provide a specific function, e.g., high hardness, on a surface layer (shell) of the resin article. Preparing the second resin has already been described above in detail, and thus, further descriptions thereof will be omitted.

According to another embodiment of the present invention, a method of preparing a resin article may include forming a melt blend by melting a pellet; and forming a layer-separated structure by processing the melt blend.

In the embodiment, a pellet may be prepared by melt-processing, such as extrusion or the like, the resin blend described above. For example, when a resin blend including a first resin and a second resin is extruded, the second resin having a greater hydrophobic property than that of the first resin may move to contact ambient air to form a shell of a pellet and the first resin may be positioned at a center of the pellet to form a core. The produced pellet may be prepared to a resin article by melt-processing such as an injection or the like. However, without being limited thereto, in another example, the resin blend may directly prepare the resin article through melt-processing such as injection.

Meanwhile, according to another embodiment of the present invention, a resin article may include a first resin layer, a second resin layer formed on the first resin layer, and an interface layer disposed between the first resin layer and the second resin layer. The interface layer may include first and second resins.

The resin article prepared from a resin blend including the specific first resin and the second resin which has a difference in physical properties from the first resin may have, e.g., a layer separated structure in which the first resin layer is located therein and the second resin layer is formed at a surface thereof.

In particular, when a resin including a particle with the above-described triple structure of a seed-core-shell polymer is used as a second resin, surface hardness of the resin article may be further improved.

The “first resin layer” mainly includes the first resin, may determine physical properties of the resin article and be positioned inside the resin article. Further, the “second resin layer” mainly includes the second resin, may be positioned outside the resin article and provide a certain function on a surface of the resin article.

Since the first resin and the second resin have already been described above in detail, related descriptions thereof will be omitted.

The resin article may include an interface layer formed between the first resin layer and the second resin layer and containing a mixture of the first resin and the second resin. The interface layer may be formed between the layer-separated first resin layer and second resin layer and serve as a boundary surface, and contain a mixture of the first resin and the second resin. The mixture may be in a state in which the first resin is physically or chemically combined with the second resin, and the first resin layer may be combined with the second resin layer by the mixture.

In the resin article, the first resin layer and the second resin layer are divided by the interface layer, and the second resin layer is exposed to the outside. For example, the resin article may include a structure in which the first resin layer, the interface layer, and the second resin layer are sequentially stacked, or a structure in which the interface layer and the second resin are stacked above and below the first resin, respectively. Alternatively, the resin article may include a structure in which the first resin layer formed in various three-dimensional shapes, e.g., spherical, circular, polyhedral, and sheet-type shapes, is sequentially surrounded by the interface layer and the second resin layer.

A layer separation generated in the resin article may be attributed to the resin article prepared by applying a specific first resin and second resin having different physical properties. The different physical properties may include, for example, surface energy or melt viscosity. Detailed descriptions regarding the physical properties are the same as described above.

In the embodiment, a first resin layer, an interface layer, and a second resin layer may be observed using a scanning electron microscope (SEM) after a low temperature impact test is performed on a test specimen and fracture surfaces of the test specimen is etched using a THF vapor. For a measurement of a thickness of each layer, the test specimen is cut with a diamond cutter using a microtoming device to obtain a smooth cross-sectional surface, and the smooth cross-sectional surface is etched using a solution capable of more selectively dissolving the second resin layer than the first resin layer. The etched cross-sectional surface is dissolved to different levels of depths according to contents of the first resin and the second resin, and when the cross-sectional surface is viewed in a 45-degree angle from a surface thereof through an SEM, the first resin layer, the second resin layer, the interface layer, and the surface may be observed due to a shade difference and a thickness of each layer may be measured. In the embodiment, as the solution more selectively dissolving the second resin, a 1,2-dichloroethane solution (10 vol %, in EtOH) is used, but this is an example and any solution having a higher solubility of the second resin than the first resin may be used without limitation, and those skilled in the art may select and apply the solution properly according to the type and composition of a second resin.

The thickness of the interface layer may be in a range of 1 to 95%, 10 to 95%, 20 to 95%, 30 to 95%, 40 to 95%, 50 to 95%, 60 to 95%, or 60 to 90% of the total thickness of the second resin layer and the interface layer. When the thickness of the interface layer is in a range of 1 to 95% of the total thickness of the second resin layer and the interface layer, an interface adhesive strength of the first and second resin layers is excellent so that both layers may not be delaminated, and the surface characteristic attributed to the second resin layer may be significantly enhanced. In comparison, when the thickness of the interface layer is much smaller than that of the second resin layer, the adhesive strength between the first and second resin layers is decreased such that both layers may be delaminated. When the interface layer is too thick, the improvement in the surface characteristic attributable to the second resin layer may be insignificant.

The second resin layer may have a thickness of 0.01 to 30%, 0.01 to 20%, 0.01 to 10%, 0.01 to 5%, 0.01 to 3%, 0.01 to 1%, or 0.01 to 0.1% of the total thickness of the resin article. As the second resin layer has a thickness in a constant range, improved surface hardness and scratch resistance may be provided on a surface of the resin article. However, when the second resin layer is too thin, it may be difficult to enhance the surface characteristic of the resin article sufficiently, and when the second resin layer is too thick, mechanical properties of the second resin may be reflected in the resin article so that mechanical properties of the first resin may be changed.

In the resin article with the above-described structure, a component of a first resin layer is detected on a surface of a second resin layer by an infrared (IR) spectrometer.

In the above, a surface of the second resin layer refers to a surface exposed to the outside (e.g., ambient air), not to the first resin layer.

Since the first resin, the second resin, and the difference in physical properties between the first resin and the second resin have already been described above in detail, related descriptions thereof will be omitted. Further, in the embodiments of present invention, a difference in physical properties between a first resin and a second resin may denote a difference in physical properties between the first resin and the second resin or a difference in physical properties between the first resin layer and the second resin layer.

In the embodiment, the resin article may be used to provide automobile components, helmets, components of electric devices, components of textile spinning machines, toys, pipes, or the like.

### Advantageous Effects

An exemplary resin of the present invention may provide the resin article of which a surface has improved mechanical properties and surface hardness. Further, since the use of the resin enables the resin article to exhibit the above-described effect without an additional coating process for the surface of the resin article, manufacturing time and cost may be reduced and productivity may be increased.

### DESCRIPTION OF DRAWINGS

FIG. 1 is a SEM image illustrating a layer-separated cross-sectional view of a resin article prepared in Example 2; and

FIG. 2 is a SEM image illustrating a cross-sectional view of a resin article prepared in Comparative Example 3.

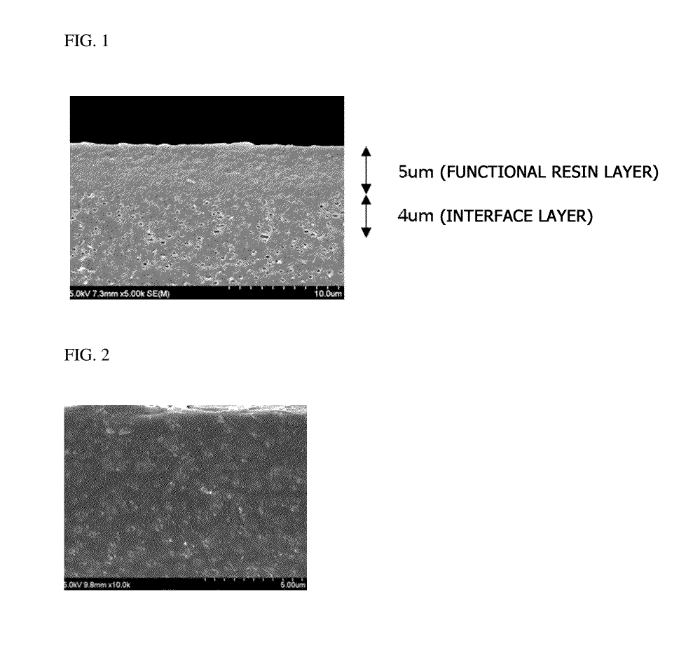

### MODE FOR INVENTION

The resin blend of the present invention will be described in detail with reference to the following Examples and Comparative Examples. While the resin blend of the present invention is shown and described in connection with exemplary embodiments thereof, it will be apparent to those skilled in the art that the scope of the resin blend is not limited by the Examples shown below.

The physical properties in Examples and Comparative Examples are evaluated by the following method.

1. Measurement of Surface Energy

According to the Owens-Wendt-Rabel-Kaelble method, surface energy was measured using a drop shape analyzer (DSA100; manufactured by KRUSS GmbH).

More specifically, resins obtained from Examples and Comparative Examples were dissolved in a methyl ethyl ketone solvent to have a concentration of 15 wt % and a precipitate thereof was removed using a centrifuge, and then the resins were coated on a LCD glass by bar coating. Then, the coated LCD glass was pre-dried in an oven at 60° C. for 2 minutes and then dried at 90° C. for one minute.

After drying (or curing), deionized water and diiodomethane each were dropped 10 times on the coated surface, to obtain an average value of a contact angle, and surface energy was calculated by substituting a numerical value into the Owens-Wendt-Rabel-Kaelble method.

2. Determination of a Cross-Section Shape

A low temperature impact test is performed on test specimens of Examples and Comparative Examples and fracture surfaces of the test specimens were etched using THF vapor, and then layer-separated cross-section shapes were observed using an SEM (product name: S-4800; manufactured by Hitachi, Ltd.).

The observed cross-section shapes were evaluated by the following standard.

∘: a full layer-separation was observed.

Δ: an insufficient layer-separation was observed.

x: no layer-separation was observed.

3. Measurement of Strength

According to ASTM D256, the strength of each test specimen obtained from Examples and Comparative Examples was measured. More specifically, an amount of energy (kg*cm/cm) required when the test specimen having a V-notch is broken by a swinging pendulum was measured using an impact tester (Impact 104, Tinius Olsen, Inc.). The tests were performed 5 times for each of ⅛″ and ¼″ test specimens, and average values were obtained.

4. Experiment for Measuring Pencil Hardness

Pencil hardness of surfaces of test specimens obtained from Examples and Comparative Examples was measured under a predetermined load of 500 g using a pencil hardness tester (Chungbuk Tech). Scratches were made on surfaces of the test specimens by varying standard pencils (Mitsubishi Corporation) in a range of 6B to 9H with maintaining an angle of 45 degrees, and then a change rate of each surface was observed (ASTM 3363-74). The results of the measurement are average values of the results of the tests which were repeatedly performed 5 times.

5. Surface Analysis by Infrared (IR) Spectrometer

The surface analysis was performed using a UMA-600 infrared microscope having a Varian FTS-7000 spectrometer (Varian, Inc., USA) and a mercury cadmium telluride (MCT) detector, and spectra measurement and data processing were fulfilled using Win-IR PRO 3.4 software (Varian, Inc., USA). Conditions of the surface analysis were as follows:
Germanium (Ge) ATR crystal having refractive index of 4.0
Spectral resolution of middle infrared spectrum obtained by attenuated total reflection (ATR) is 8 cm⁻¹ and range of 16 scans is in 4000 cm⁻¹ to 600 cm⁻¹
Internal reference band: carbonyl group (C═O str., ˜1725 cm⁻¹) of acrylate
Original component of first resin: butadiene compound [C═C str. (˜1630 cm⁻¹) or ═C—H out-of-plane vib. (˜970 cm⁻¹)]

Peak intensity ratios [IBD(C═C)/IA(C═O)] and [IBD(out-of-plane)/IA(C═O)] were calculated, and the detection of spectra was performed 5 times in different regions of one test specimen, and thereby an average value and a standard deviation were calculated.

### PREPARATION EXAMPLE

### Preparation of Second Resin

### Preparation Example 1

### (A) Polymerization of Seed

A 4-necked flask reactor having a stirrer, a thermometer, a nitrogen inlet and a rotation condenser was prepared, and 546.4 g of deionized water (DDI water) was added into a 3 L container, and then an internal temperature of the reactor was heated up to 80° C. under a nitrogen atmosphere. Subsequently, 29.4 g of methyl methacrylate (hereinafter, MMA), 0.6 g of allyl methacrylate (hereinafter, AMA), and 6 g of sodium lauryl sulfate (hereinafter, SLS, 3%) as an anionic surfactant were added into the reactor and the reactor was stirred for 15 minutes. Thereafter, 10 g of potassium persulfate (hereinafter, PPS) solution (3%) as a water-soluble polymerization initiator was added to the reactor and the reactor was stirred for 120 minutes. After completing the reaction, an emulsion of a seed polymer in a glass phase having an average diameter of 110 nm was obtained, and at this time, a conversion rate was measured as 98%.

### (B) Polymerization of Core

20 g of PPS solution (3%) was added into the emulsion and the emulsion was stirred for 15 minutes, and a mixture solution of 251.1 g of MMA, 107.6 g of phenyl methacrylate (hereinafter, PHMA), 7.3 g of AMA, and 61 g of SLS (3%) was prepared and added dropwise into the reactor at a rate of 3 g per minute. After adding dropwise, 20 g of PPS solution (3%) was added to the reactor and polymerization further proceeded for 30 minutes to prepare an emulsion with particles in which the seed was grafted with a core polymer in a rubber phase. The conversion rate of the prepared core latex polymer was measured as 97% and an average diameter of the particles was measured as 275 nm.

### (C) Polymerization of Shell

20 g of PPS solution (3%) was added to the emulsion and the emulsion was stirred for 15 minutes. Then, a mixture solution of 60 g of SLS (3%), 147 g of MMA, 52.5 g of PHMA, 10.5 g of methacryloxypropyl-terminated polydimethylsiloxane (PDMS, Mw: 420), and 0.6 g of n-dodecyl mercaptane as a chain transfer agent was prepared and added dropwise into the reactor at a rate of 3 g per minute. After adding dropwise was completed, 20 g of PPS solution (3%) was added into the reactor and polymerization proceeded for 30 minutes. After completing polymerization, an emulsion with particles in which the core was grafted with a shell polymer in a glass phase was prepared. An average diameter of the particles was measured as 300 nm.

### (D) Preparation of Second Resin

The emulsion was added dropwise into a magnesium sulfate solution (1%) preheated to 80° C. and stirred to prepare a solid in a powder form. The powder was washed 3 times using distilled water of 70° C. after being filtered, and dried in a vacuum oven at 80° C. for 24 hours to prepare a functional resin composed of 5 parts by weight of a seed, 60 parts by weight of a core, and 35 parts by weight of a shell.

### Preparation Example 2

### (A) Polymerization of Seed

A 4-necked flask reactor having a stirrer, a thermometer, a nitrogen inlet, and a rotation condenser was prepared, and 1647.6 g of DDI water was added into a 3 L container, and then an internal temperature of the reactor was heated up to 80° C. under a nitrogen atmosphere. Subsequently, 294 g of MMA, 6 g of AMA, and 40 g of SLS were input into the reactor and the reactor was stirred for 15 minutes. Thereafter, 20 g of PPS solution (3%) was added to the reactor and the reactor was stirred for 120 minutes. After completing the reaction, an emulsion of a seed polymer in a glass phase having an average diameter of 100 nm was obtained, and at this time, a conversion rate was measured as 98%.

### (B) Polymerization of Core

120 g of PPS solution (3%) was added into the emulsion and the emulsion was stirred for 15 minutes, and a mixture solution of 62.8 g of MMA, 26.9 g of PHMA, 1.8 g of AMA and 20.3 g of SLS (3%) was prepared and added dropwise into the reactor at rate of 3 g per minute. After adding dropwise, 10 g of PPS solution (3%) was further added to the reactor and polymerization further proceeded for 30 minutes to prepare an emulsion with particles in which the seed was grafted with a core polymer in a rubber phase. The conversion rate of the prepared core latex polymer was measured as 97% and an average diameter of the particles was measured as 110 nm.

### (C) Polymerization of Shell

20 g of PPS solution (3%) was added to the emulsion and the emulsion was stirred for 15 minutes. Then, a mixture solution of 60 g of SLS (3%), 147 g of MMA, 52.5 g of PHMA, 10.5 g of methacryloxypropyl-terminated polydimethylsiloxane (PDMS, Mw: 420), and 0.6 g of n-dodecyl mercaptane as a chain transfer agent was prepared and added dropwise into the reactor at rate of 3 g per minute. After adding dropwise was completed, 20 g of PPS solution (3%) was added into the reactor and polymerization proceeded for 30 minutes. After completing polymerization, an emulsion with particles in which the core was grafted with a shell polymer in a glass phase was prepared. An average diameter of the particles was measured as 126 nm.

### (D) Preparation of Second Resin

The emulsion was added dropwise into a magnesium sulfate solution (1%) preheated to 80° C. and stirred to prepare a solid in a powder form. The powder was washed 3 times using distilled water of 70° C. after being filtered and dried in a vacuum oven at 80° C. for 24 hours to prepare a functional resin composed of 50 parts by weight of a seed, 15 parts by weight of a core, and 35 parts by weight of a shell.

### Example 1

After 90 parts by weight of a first resin (a thermoplastic resin composed of 60 parts by weight of methylmethacrylate, 7 parts by weight of acrylonitrile, 10 parts by weight of butadiene, and 23 parts by weight of styrene) was blended with 10 parts by weight of the second resin prepared in Preparation Example 1, the blend was extruded using a twin-screw extruder (Leistritz Pumpen GmbH) at 240° C., and thereby a pellet was obtained. Then, the pellet was injected using an EC100130 injector (Engel Austria GmbH) at 240° C., and a test specimen of a resin article was prepared.

In the test specimen of the resin article, a layer separation phenomenon, in which a first resin layer, a second resin layer, and an interface layer having a thickness of 10 μm between the first resin layer and the second resin layer are divided, has been generated.

The surface energy of the second resin layer was measured as 30 mN/m, and a difference in surface energy between the first resin layer and the second resin layer was measured as 13 mN/m.

Further, strength of each of the test specimens ⅛″ and ¼″ was measured as 9, pencil hardness of the test specimens was measured as 2H, and analysis results of IR spectrometer were measured as I_{BD}(C═C)/I_{PMMA}(C═O)=0.0119±0.0005, I_{BD}(out-of-plane)/I_{PMMA}(C═O)=0.402±0.0029.

### Example 2

A test specimen of a resin article was prepared in the same manner as in Example 1, except that 10 parts by weight of the second resin prepared in Preparation Example 2 was blended with 90 parts by weight of a first resin.

In the test specimen of the resin article, a layer separation phenomenon, in which a first resin layer, a second resin layer, and an interface layer having a thickness of 3 μm between the first resin layer and the second resin layer are divided, has been generated.

The surface energy of the second resin layer was measured as 29 mN/m, and a difference in surface energy between the first resin layer and the second resin layer was measured as 14 mN/m.

Further, strength of each of the test specimens ⅛″ and ¼″ was measured as 9, and pencil hardness of the test specimens was measured as H.

### Comparative Example 1

A pellet formed of 100 parts by weight of the first resin used in Example 1 was dried in an oven and injected using an EC100130 injector (Engel Austria GmbH) at 240° C. to prepare a test specimen.

The surface energy of the first resin layer was measured as 43 mN/m.

Further, strength of each of the test specimens ⅛″ and ¼″ was measured as 10, and pencil hardness of the test specimens was measured as F.

### Comparative Example 2

A test specimen of a resin article was prepared in the same manner as in Example 1, except that PMMA (LGMMA IF870) was used as a second resin.

In the test specimen of the resin article, no layer separation had occurred.

The surface energy of the second resin layer was measured as 43 mN/m, and there was no difference in surface energy between the first resin layer and the second resin layer.

Further, strength of each of the test specimens ⅛″ and ¼″ was measured as 5, and pencil hardness of the test specimens was measured as H.

### Comparative Example 3

A test specimen of the resin article was prepared in the same manner as in Example 1, except that crosslinked PMMA (Sekisui XX-110BQ) was used as a second resin.

In the test specimen of resin article, no layer separation had occurred. Further, strength of the test specimens ⅛″ and ¼″ was measured as 3 and 4, respectively, and pencil hardness of the test specimens was measured as HB.

### Comparative Example 4

A pellet formed of 100 parts by weight of the first resin used in Example 1 was dried in an oven and injected using an EC100130 injector (Engel Austria GmbH) at 240° C. to prepare a test specimen.

A contamination-resistant hard coating solution prepared by the inventor including a multifunctional acrylate (17.5 parts by weight of DPHA, 10 parts by weight of PETA, 1.5 parts by weight of perfluorohexylethyl methacrylate, 5 parts by weight of urethane acrylate (EB 1290) from SK CYTEC Co., Ltd., 45 parts by weight of methyl ethyl ketone, 20 parts by weight of isopropyl alcohol, and 1 parts by weight of IRGACURE® 184 as a UV initiator from Ciba Specialty Chemicals Corporation) was coated on the test specimen using a May bar #9 and the coating was dried at 60 to 90° C. for 4 minutes to form a coating film, and the coating solution composition was radiated with UV irradiation at an intensity of 3,000 mJ/cm² for curing such that a hard coating layer was formed

The pencil hardness of the test specimen was measured as 3H, and IBD(C═C)/IPMMA(C═O) and IBD(out-of-plane)/IPMMA(C═O) detected by an IR spectrometer each were 0.

When the resin blend in accordance with Examples was used, a layer separation phenomenon was generated between resins during an extrusion and injection process. According to the layer separation phenomenon, a high hardness resin was located on a surface of the resin article such that the prepared resin article exhibited excellent surface hardness without an additional coating or painting process.

On the contrary, since a layer separation phenomenon between the resins as shown in the resin blend according to Examples was not observed in the resin blend according to Comparative Examples and the prepared resin article thereof also had low surface hardness, it has been exhibited that such the resin blend was hard to use for automobile components, components of electric devices, and the like without an additional coating or painting process.

1. A resin which includes a particle comprising:
a seed containing a polymer derived from an alkyl (meth)acrylate monomer and a crosslinkable monomer;
a core surrounding the seed and containing a polymer derived from an alkyl (meth)acrylate monomer, an aryl (meth)acrylate monomer, and a crosslinkable monomer; and
a shell surrounding the core and containing a polymer derived from an alkyl (meth)acrylate monomer, an aryl (meth)acrylate monomer, and a compound of the following Formula 1: 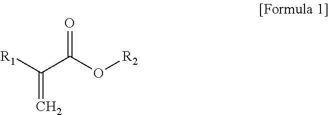
In Formula 1, R₁ represents hydrogen or an alkyl having 1 to 5 carbon atoms, and R₂ represents a compound of the following Formula 2. 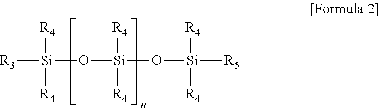
In Formula 2, R₃ represents an alkylene having 1 to 8 carbon atoms, R₄ and R₅ each independently represent hydrogen or an alkyl having 1 to 8 carbon atoms, and n represents an integer of 1 to 100.

2. The resin of claim 1, wherein the alkyl (meth)acrylate monomer comprises one or more selected from a group consisting of methyl methacrylate, ethyl methacrylate, methyl acrylate, ethyl acrylate, n-propyl acrylate, isopropyl acrylate, n-butyl acrylate, isobutyl acrylate, hexyl acrylate, octyl acrylate, and 2-ethylhexyl acrylate.

3. The resin of claim 1, wherein the aryl (meth)acrylate monomer comprises one or more selected from a group consisting of naphthyl (meth)acrylate, phenyl (meth)acrylate, anthracenyl (meth)acrylate, and benzyl (meth)acrylate.

4. The resin of claim 1, wherein the crosslinkable monomer comprises one or more selected from a group consisting of 3-butanediol diacrylate, 1,3-butanediol dimethacrylate, 1,4-butanediol diacrylate, 1,4-butanediol dimethacrylate, allyl acrylate, allyl methacrylate, trimethylolpropane triacrylate, tetraethyleneglycol diacrylate, tetraethyleneglycol dimethacrylate, and divinylbenzene.

5. (canceled)

6. The resin of claim 1, wherein the seed comprises the polymer derived from a range of 5 to 99.5 parts by weight of the alkyl (meth)acrylate monomer and a range of 0.5 to 5 parts by weight of the crosslinkable monomer.

7. (canceled)

8. The resin of claim 1, wherein the core comprises the polymer derived from a range of 10 to 80 parts by weight of the alkyl (meth)acrylate monomer, a range of 20 to 40 parts by weight of the aryl (meth)acrylate monomer, and a range of 0.01 to 5 parts by weight of the crosslinkable monomer.

9. (canceled)

10. The resin of claim 1, wherein the shell comprises the polymer derived from a range of 10 to 90 parts by weight of the alkyl (meth)acrylate monomer, a range of 20 to 30 parts by weight of the aryl (meth)acrylate monomer, and a range of 1 to 50 parts by weight of the compound of Formula 1.

11.-12. (canceled)

13. A method of preparing a resin, which is performed in the presence of an anionic surfactant and a polymerization initiator and comprising:
(A) preparing a seed by polymerizing an alkyl (meth)acrylate monomer and a crosslinkable monomer;
(B) preparing a core, in the presence of the seed, by additionally polymerizing an alkyl (meth)acrylate monomer, an aryl (meth)acrylate monomer, and a crosslinkable monomer; and
(C) preparing a shell, in the presence of the core, by polymerizing an alkyl (meth)acrylate monomer, an aryl (meth)acrylate monomer, and a compound of the following Formula 1, using a water-soluble initiator: 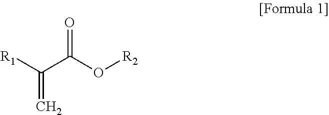
In Formula 1, R₁ represents hydrogen or an alkyl having 1 to 5 carbon atoms, and R₂ represents a compound of the following Formula 2. 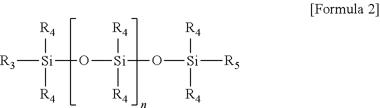
In Formula 2, R₃ represents an alkylene having 1 to 8 carbon atoms, R₄ and R₅ each independently represent hydrogen or an alkyl having 1 to 8 carbon atoms, and n represents an integer of 1 to 100.

14.-15. (canceled)

16. A resin blend, comprising:
a first resin; and
a second resin which is an acrylic polymer having a difference in surface energy, melt viscosity, or solubility parameter from the first resin,
wherein the second resin comprises a particle including:
a seed containing a polymer derived from an alkyl (meth)acrylate monomer and a crosslinkable monomer;
a core surrounding the seed and containing a polymer derived from an alkyl (meth)acrylate monomer, an aryl (meth)acrylate monomer, and a crosslinkable monomer; and
a shell surrounding the core and containing a polymer derived from an alkyl (meth)acrylate monomer, an aryl (meth)acrylate monomer, and a compound of the following Formula 1: 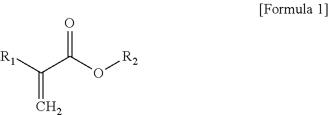
In Formula 1, R₁ represents hydrogen or an alkyl having 1 to 5 carbon atoms, and R₂ represents a compound of the following Formula 2. 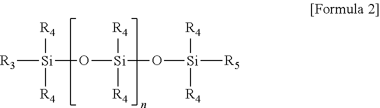
In Formula 2, R₃ represents an alkylene having 1 to 8 carbon atoms, R₄ and R₅ each independently represent hydrogen or an alkyl having 1 to 8 carbon atoms, and n represents an integer of 1 to 100.

17. The resin blend of claim 16, wherein the second resin has a difference of 0.1 to 35 mN/m in surface energy from a first resin at 25° C.

18.-20. (canceled)

21. The resin blend of claim 16, wherein the alkyl (meth)acrylate monomer comprises one or more selected from a group consisting of methyl methacrylate, ethyl methacrylate, methyl acrylate, ethyl acrylate, n-propyl acrylate, isopropyl acrylate, n-butyl acrylate, isobutyl acrylate, hexyl acrylate, octyl acrylate, and 2-ethylhexyl acrylate.

22. The resin blend of claim 16, wherein the aryl (meth)acrylate monomer comprises one or more selected from a group consisting of naphthyl (meth)acrylate, phenyl (meth)acrylate, anthracenyl (meth)acrylate, and benzyl (meth)acrylate.

23. The resin blend of claim 16, wherein the crosslinkable monomer comprises one or more selected from a group consisting of 3-butanediol diacrylate, 1,3-butanediol dimethacrylate, 1,4-butanediol diacrylate, 1,4-butanediol dimethacrylate, allyl acrylate, allyl methacrylate, trimethylolpropane triacrylate, tetraethyleneglycol diacrylate, tetraethyleneglycol dimethacrylate, and divinylbenzene.

24. (canceled)

25. The resin blend of claim 16, wherein the seed comprises the polymer derived from a range of 5 to 99.5 parts by weight of the alkyl (meth)acrylate monomer and a range of 0.5 to 5 parts by weight of the crosslinkable monomer.

26. (canceled)

27. The resin blend of claim 16, wherein the core comprises the polymer derived from a range of 10 to 80 parts by weight of the alkyl (meth)acrylate monomer, a range of 20 to 40 parts by weight of the aryl (meth)acrylate monomer, and a range of 0.01 to 5 parts by weight of the crosslinkable monomer.

28. (canceled)

29. The resin blend of claim 16, wherein the shell comprises the polymer derived from a range of 10 to 90 parts by weight of the alkyl (meth)acrylate monomer, a range of 20 to 30 parts by weight of the aryl(meth)acrylate monomer, and a range of 1 to 50 parts by weight of the compound of Formula 1.

30.-34. (canceled)

35. A pellet comprising:
a core formed of a first resin; and
a shell formed of a second resin, which is different in surface energy, melt viscosity, or the solubility parameter from the first resin,
wherein the second resin comprises a particle including:
a seed containing a polymer derived from an alkyl (meth)acrylate monomer and a crosslinkable monomer;
a core surrounding the seed and containing a polymer derived from an alkyl (meth)acrylate monomer, an aryl (meth)acrylate monomer, and a crosslinkable monomer; and
a shell surrounding the core and containing a polymer derived from an alkyl (meth)acrylate monomer, an aryl (meth)acrylate monomer, and a compound of the following Formula 1: 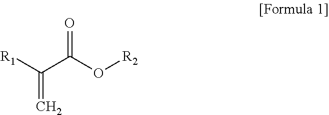
In Formula 1, R₁ represents hydrogen or an alkyl having 1 to 5 carbon atoms, and R₂ represents a compound of the following Formula 2. 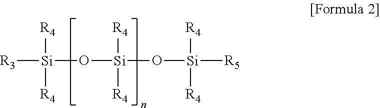
In Formula 2, R₃ represents an alkylene having 1 to 8 carbon atoms, R₄ and R₅ each independently represent hydrogen or an alkyl having 1 to 8 carbon atoms, and n represents an integer of 1 to 100.

36. A method of preparing a resin article, comprising:
forming a melt blend by melting the resin blend of claim 16; and
forming a layer-separated structure by processing the melt blend.

37. The method of claim 36, wherein a step of melting and processing is performed under shear stress.

38.-39. (canceled)

40. A method of preparing a resin article, comprising:
forming a melt blend by melting the pellet of claim 35; and
forming a layer-separated structure by processing the melt blend.

41. A resin article, comprising:
a first resin layer;
a second resin layer formed on the first resin layer; and
an interface layer including a first resin and a second resin and formed between the first resin layer and the second resin layer,
wherein the second resin comprises a particle including:
a seed containing a polymer derived from an alkyl (meth)acrylate monomer and a crosslinkable monomer;
a core surrounding the seed and containing a polymer derived from an alkyl (meth)acrylate monomer, an aryl (meth)acrylate monomer, and a crosslinkable monomer; and
a shell surrounding the core and containing a polymer derived from an alkyl (meth)acrylate monomer, an aryl (meth)acrylate monomer, and a compound of the following Formula 1: 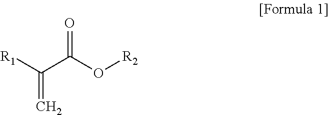
In Formula 1, R₁ represents hydrogen or an alkyl having 1 to 5 carbon atoms, and R₂ represents a compound of the following Formula 2. 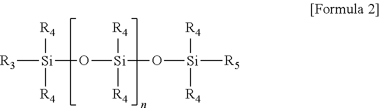
In Formula 2, R₃ represents an alkylene having 1 to 8 carbon atoms, R₄ and R₅ each independently represent hydrogen or an alkyl having 1 to 8 carbon atoms, and n represents an integer of 1 to 100.

42. (canceled)
